(19) United States
(12) Patent Application Publication
(10) Pub. No.: US 2018/0266491 A1
(43) Pub. Date: Sep. 20, 2018

(54) TRIPOD TYPE CONSTANT VELOCITY UNIVERSAL JOINT

(71) Applicant: NTN CORPORATION, Osaka (JP)

(72) Inventors: Tatsuro SUGIYAMA, Shizuoka (JP); Ritsuki SAKIHARA, Shizuoka (JP)

(21) Appl. No.: 15/761,208

(22) PCT Filed: Aug. 25, 2016
(86) PCT No.: PCT/JP2016/074851

§ 371 Date: Mar. 19, 2018

(30) Foreign Application Priority Data
Sep. 24, 2015 (JP) 2015-187285

(51) Int. Cl. F16D 3/205

(52) U.S. Cl. CPC F16D 3/2055; F16D 2003/2023

(57) ABSTRACT

A tripod type constant velocity universal joint includes an outer joint member having track grooves formed at trisected positions in a circumferential direction to extend in an axial direction thereof, and a tripod member. The tripod member includes a trunnion barrel and trunnion journals radially projecting from trisected positions on the trunnion barrel in the circumferential direction. The universal joint also includes spherical rollers each fitted in a rotatable manner about each of the trunnion journals through intermediation of a plurality of needle rollers. The spherical rollers are in the track grooves, and each has an outer spherical surface guided by roller guide surfaces formed on both side walls of each of the track grooves. Hollow holes are formed in the trunnion journals, respectively, and a quench-hardened layer is formed on each of outer circumferential surfaces of the trunnion journals and surfaces of the hollow holes.

### TECHNICAL FIELD

The present invention relates to a plunging tripod type constant velocity universal joint to be used for power transmission in automobiles, industrial machines, and the like.

### BACKGROUND ART

As illustrated in FIG. 15a and FIG. 15b, a tripod type constant velocity universal joint 51 includes an outer joint member 52 having, three track grooves 53 formed at trisected positions in a circumferential direction to extend in an axial direction, and roller guide surfaces 54 formed on opposing side walls of each track groove 53, a tripod member 60 including trunnion journals 62 radially projecting from trisected positions on a trunnion barrel 61 in the circumferential direction, and spherical rollers 70 each fitted in a freely rotatable manner about each trunnion journal 62 through intermediation of a plurality of needle rollers 72. The spherical rollers 70 are received in the track grooves 53 of the outer joint member 52, and an outer spherical surface of each spherical roller 70 is guided by the roller guide surfaces 54 formed on both the side walls of each track groove 58 (See Patent Document 1).

### PRIOR ART DOCUMENTS

### Patent Documents

Patent Document 1: JP 3947342

### SUMMARY OF THE INVENTION

### Problems to be Solved by the Invention

In the tripod type constant velocity universal joint 51 disclosed in Patent Document 1, in consideration of the strength and durability, the outer diameter of the outer joint member is reduced to achieve weight reduction and compactification. To achieve the weight reduction and compactification in the tripod type constant velocity universal joint 51, focusing on the fact that an extra margin is secured for durability in view of the balance between strength and durability, dimensional ratios are reviewed for the purpose of keeping the balance between strength and durability.

Contact portions of components of the tripod type constant velocity universal joint 51 are subjected to heat treatment to secure rolling life and strength. As illustrated in FIG. 18, the tripod member 80 requires a quench-hardened layer on an outer circumferential surface 80 of the trunnion journal 62, which serves as an inner raceway surface for the needle rollers 72 (see FIG. 15a and FIG. 15b), and on a spline 61a. Therefore, carburizing, quenching, and tempering are typically performed to form a substantially uniform hardened layer h on an entire surface.

An effective hardened layer depth of the quench-hardened layer on the entire surface of the tripod member 60 is set to an effective hardened layer depth (for example, about 1 mm) required for securing the rolling life of the outer circumferential surface 80 of the trunnion journal 62, which serves as the inner raceway surface for the needle rollers 72. The effective hardened layer depth is small with respect to a diameter (journal diameter) of the outer circumferential surface 80 of the trunnion journal 62. As the journal diameter increases, the tripod member 60 becomes heavier by the amount corresponding to the increase in journal diameter.

Herein, the effective hardened layer depth is defined as a depth range having a minimum value obtained by multiplying a value of a maximum shear stress generating depth ZST, which is calculated based on a contact portion load and a contact ellipse of the outer circumferential surface 80 of the trunnion journal 62 given during application of high torque to the constant velocity universal joint, by a safety factor 1.5 times to 3 times). Further, the effective hardened layer depth generally has a range of Hv 513 (HRC 50) or more, and an overall hardened layer depth has a range which is obtained through hardening by heat treatment to a material hardness higher than that given before heat treatment. The material hardness is from about Hv 300 to Hv 390 (from about HRC 80 to about HRC 40).

In FIG. 17, there is shown hardness distribution from a surface S of the outer circumferential surface 80 of the trunnion journal 62 of FIG. 16 to an inner portion. In FIG. 17, De represents the effective hardened layer depth, and Dt represents the overall hardened layer depth.

In recent years, however, there has been increasing a demand for higher fuel efficiency of automobiles, thereby arousing a strong desire for further weight reduction of the constant velocity universal joint as one of the components of automobiles. It has been found that any means being extension of the tripod constant velocity universal joint 51 disclosed in Patent Document 1 cannot meet the above-mentioned demand.

In view of the above-mentioned problem, the present invention has an object to provide a tripod type constant velocity universal joint which achieves weight reduction while maintaining the strength and life.

### Solution to the Problems

As a result of various studies conducted to achieve the above-mentioned object, the inventors of the present invention have conceived of forming a hollow hole in a trunnion journal and forming a quench-hardened layer on a surface of the hollow hole.

As technical means for achieving the above-mentioned object, according to one embodiment of the present invention, there is provided a tripod type constant velocity universal joint, comprising: an outer joint member having track grooves formed at trisected positions in a circumferential direction of the outer joint member to extend in an axial direction thereof; a tripod, member comprising: a trunnion barrel to be spline-fitted on a shaft to allow torque transmission therebetween; and trunnion journals radially projecting from trisected positions on the trunnion barrel in the circumferential direction; and spherical rollers each fitted in a rotatable manner about each of the trunnion journals through intermediation of a plurality of needle rollers, the spherical rollers being received in the track grooves, and each having an outer spherical surface guided by roller guide surfaces formed on both side walls of each of the track grooves, wherein hollow holes are formed in the trunnion journals, respectively, and wherein a quench-hardened layer necessary for rolling life is formed on each of outer circumferential surfaces of the trunnion journals and surfaces of the hollow holes. With this configuration, the tripod constant velocity universal joint which is reduced in weight while maintaining the strength and life can be achieved.

It is desired that the above-mentioned hollow holes each have a cylindrical shape having a bottom portion, and that the quench-hardened layer be formed also on a surface of the bottom portion. When the quench-hardened layer which is continuous on an entire surface of the hollow hole including the bottom portion is formed, the strength and stiffness of the trunnion journal can be increased.

Now, the quench-hardened layer described in Claims and Description are defined as follows. As mentioned above, the effective hardened layer depth is defined as a depth range having a minimum value obtained, by multiplying a value of a maximum shear stress generating depth ZST, which is calculated based on a contact portion load and a contact ellipse of the outer circumferential, surface 80 of the trunnion journal 62 given during application of high torque to the constant velocity universal joint, by a safety factor (1.5 times to 3 times). The effective hardened layer depth is generally defined as a range of Hv 513 (HRC 50) or more. Further, the quench-hardened layer described in Claims and Description is defined as a hardened layer having the effective hardened layer depth defined as described above. The overall hardened layer depth is defined as a range which is obtained through hardening by heat treatment to a material hardness higher than that given before heat treatment. The material hardness is from about Hv 300 to about Hv 390 (from about HRC 30 to about HRC 40).

It is desired that the above-mentioned hollow holes each have an elliptical cylinder shape having a bottom portion, and a long axis of an ellipse be arranged in a direction orthogonal to an axis of the tripod type constant velocity universal joint, and that the quench-hardened layer be formed also on a surface of the bottom portion. Together with, the increase in stiffness of the trunnion journals by the hollow hole having an elliptical cylinder shape, when the quench-hardened layer which is continuous on the entire surface of the hollow hole including the bottom portion is formed, the strength and stiffness can further be increased.

When the carburizing, quenching, and tempering are performed as the above-mentioned heat treatment, the quench-hardened layer can be formed on the outer circumferential surface of the trunnion journal and on the surface of the hollow hole with high productivity.

When a core hardness of the above-mentioned trunnion journals is higher than a core hardness of the trunnion barrel, the strength and stiffness of the trunnion journal can be increased.

When the hollow hole of each of the above-mentioned trunnion journal is formed of a forged surface, additional processing is not required, thereby being capable of reducing the manufacturing cost.

### Effects of the Invention

With the tripod type constant velocity universal joint according to the present invention, the tripod type constant velocity universal joint which is reduced in weight while maintaining the strength and life can be achieved.

### BRIEF DESCRIPTION OF DRAWINGS

FIG. 1a is a transverse sectional view for illustrating a tripod type constant velocity universal joint according to a first embodiment of the present invention.

FIG. 1b is a longitudinal sectional view for illustrating the tripod type constant velocity universal joint according to the first embodiment of the present invention.

FIG. 2a is a transverse sectional view for illustrating dimensions of portions in the tripod type constant velocity universal joint of FIG. 1a.

FIG. 2b is a longitudinal sectional view for illustrating dimensions of a tripod member having a spherical roller mounted thereto in the tripod type constant velocity universal joint of FIG. 1b.

FIG. 3 is a transverse sectional view for illustrating details of the tripod member of FIG. 1a.

FIG. 4a is a transverse sectional view for illustrating, a hollow hole of a trunnion journal of the tripod member of FIG. 3.

FIG. 4b is a sectional view taken along the line X-X of FIG. 4a.

FIG. 4c is an explanatory view for illustrating a size of the hollow hole of FIG. 4a.

FIG. 5a is a transverse sectional view for illustrating a quench-hardened layer of the tripod member of FIG. 1a.

FIG. 5b is a sectional view taken along the line X-X of FIG. 5a.

FIG. 6 is a graph for showing hardness distribution from a surface S1 of a cylindrical outer circumferential surface of the trunnion journal of FIG. 5a to a surface S2 of the hollow hole.

FIG. 7 is a sectional view for illustrating a modification example of the hollow hole of the trunnion journal.

FIG. 8a is a transverse sectional view for illustrating a tripod type constant velocity universal joint according to a second embodiment of the present invention.

FIG. 8b is a longitudinal sectional view for illustrating a tripod type constant velocity universal joint according to the second embodiment of the present invention.

FIG. 9 is a transverse sectional view for illustrating dimensions of portions of the tripod type constant velocity universal joint of FIG. 8a.

FIG. 10 is a transverse sectional view for illustrating a state of contact between a spherical roller and a roller guide surface of FIG. 8a.

FIG. 11 is a transverse sectional view for illustrating detail of a tripod member of FIG. 8a.

FIG. 12a is a transverse sectional view for illustrating a hollow hole of a trunnion journal of the tripod member of FIG. 8a.

FIG. 12b is a sectional view taken along the line X₂-X₂ of FIG. 12a.

FIG. 12c is an explanatory view for illustrating a size of the hollow hole of FIG. 12a.

FIG. 13a is a transverse sectional view for illustrating a quench-hardened layer of the tripod member of FIG. 8a.

FIG. 13b is a sectional view taken along the line X₂-X₂ of FIG. 13a,

FIG. 14 is a sectional view for illustrating a modification example of the hollow hole of the trunnion journal.

FIG. 15a is a transverse sectional view for illustrating a related-art tripod type constant velocity universal joint.

FIG. 15b is a longitudinal sectional view for illustrating the related-art tripod type constant velocity universal joint.

FIG. 16 is a transverse sectional view for illustrating a quench-hardened layer of a tripod member of FIG. 15a.

FIG. 17 is a graph for showing hardness distribution from a surface S of an outer circumferential surface of a trunnion journal of FIG. 16 to an inner portion.

### EMBODIMENTS OF THE INVENTION

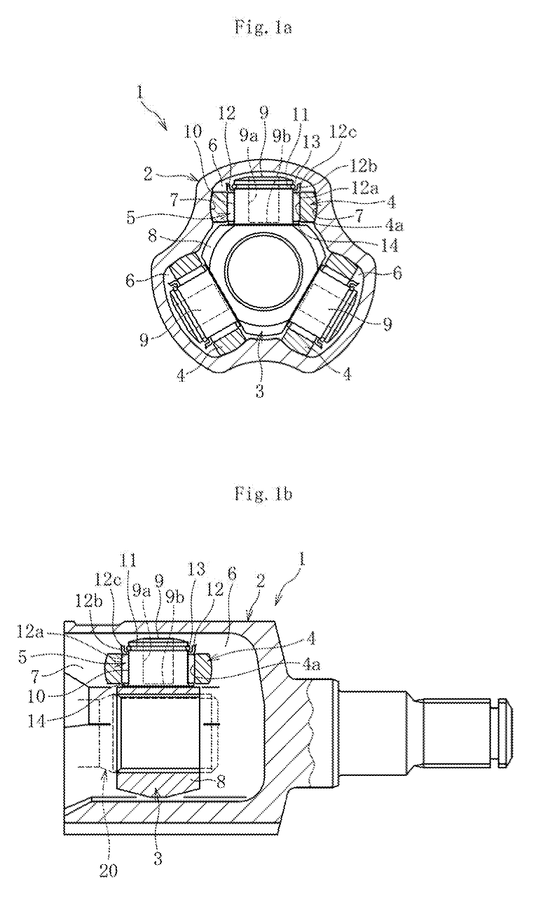

A first embodiment of the present invention is described with reference to FIGS. 1 to FIG. 6.

FIG. 1a is a transverse sectional view for illustrating a tripod type constant velocity universal joint according to the first embodiment of the present invention. FIG. 1b is s longitudinal sectional view for illustrating the tripod type constant velocity universal joint according to the first embodiment of the present invention. As illustrated in FIG. 1a and FIG. 1b, a tripod type constant velocity universal joint 1 mainly comprises an outer joint member 2, a tripod member 3 serving as an inner joint member, spherical rollers 4, and needle rollers 5 serving as rolling elements. The outer joint member 2 has a hollow cup shape with three track grooves 6 formed on an inner circumference thereof at trisected positions in a circumferential direction to extend in an axial direction. Roller guide surfaces 7 are formed on opposing side walls of each track groove 6. The roller guide surfaces 7 are formed as parts of a cylindrical surface, that is, as partial cylindrical surfaces.

The tripod member 3 comprises a trunnion barrel 8 and trunnion journals 9. Three trunnion journals 9 are formed to radially project from trisected positions on the trunnion barrel 8 in the circumferential direction. The trunnion barrel 8 is spline-fitted on a shaft 20 to allow torque transmission therebetween. Each trunnion journal 9 has a cylindrical outer circumferential surface 10 and an annular retaining ring groove 11 formed in the vicinity of a shaft end of the trunnion journal 9. The spherical roller 4 is fitted in a freely rotatable manner about the cylindrical outer circumferential surface 10 of the trunnion journal 9 through intermediation of the plurality of needle rollers 5. The cylindrical outer circumferential surface 10 of the trunnion journal 9 serves as an inner raceway surface of the needle rollers 5. An inner circumferential surface 4a of the spherical roller 4 has a cylindrical shape and serves as an outer raceway surface of the needle rollers 5. A hollow hole 9a having a cylindrical shape is formed at the center of the trunnion journal 9, and the hollow hole 9a has a bottom portion 9b.

In the retaining ring groove 11 formed in the vicinity of the shaft end of the trunnion journal 9, a retaining ring 18 is fitted through intermediation of an outer washer 12. Movement of the needle rollers 5 in an axial direction of the trunnion journal 9 is restricted by an inner washer 14 and the outer washer 12. The outer washer 12 comprises a disc portion 12a extending in a radial direction of the trunnion journal 9, and a cylindrical portion 12b extending in the axial direction of the trunnion journal 9. The cylindrical portion 12b of the outer washer 12 has an outer diameter that is smaller than a diameter of the inner circumferential surface 4a of the spherical roller 4, and an end portion 12c of the cylindrical portion 12b, which is located on an outer side when viewed in a radial direction of the tripod member 3, is formed to have a diameter that is larger than that of the inner circumferential surface 4a of the spherical roller 4. Thus, the spherical roller 4 is movable in the axial direction of the trunnion journal 9, and is prevented from dropping off by the end portion 12c.

The spherical roller 4 fitted on the trunnion journal 9 of the tripod member 3 in a freely rotatable manner is guided by the roller guide surfaces 7 of the track groove 8 of the outer joint member 2 in a freely rotatable manner. With this structure, relative axial displacement and relative angular displacement between the outer joint member 2 and the tripod member 3 are absorbed so that the rotation is transmitted at constant velocity.

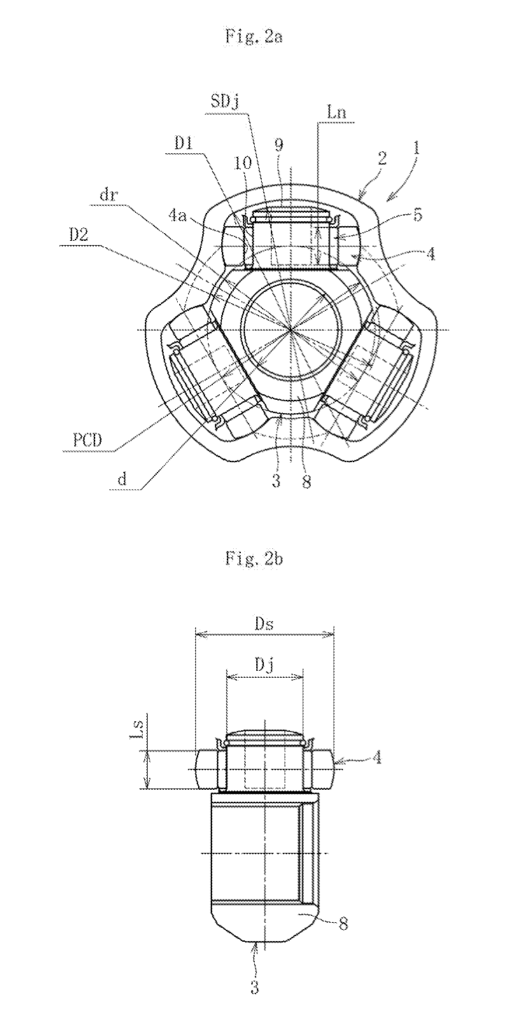

In FIG. 2a and FIG. 2b, there are shown dimensions of portions of the tripod type constant velocity universal joint 1 according to the first embodiment. FIG. 2a is a transverse sectional view, and FIG. 2b is a longitudinal sectional view for illustrating the tripod member 3 having the spherical roller 4 mounted thereto. Dimensions of portions are defined as follows.

d: shaft diameter (spline large diameter). PCD: roller guide surface pitch circle diameter, dr: trunnion barrel diameter, SDj: trunnion outer diameter, D2: small inner diameter of outer joint member, D1: large inner diameter of outer joint member, Ls: roller width, Ds: roller outer diameter, Dj: trunnion journal diameter, Ln: needle roller length

The tripod type constant velocity universal joint 1 has basic dimensional ratios as indicated by the following seven items.
(1) Shaft diameter d/roller guide surface pitch circle diameter PCD (d/PCD)
(2) Trunnion barrel diameter dr/trunnion outer diameter SDj (dr/SDj)
(3) Small inner diameter D2/large inner diameter D1 of outer joint member (D2/D1)
(4) Roller width Ls/roller outer diameter Ds (Ls/Ds)
(5) Trunnion journal diameter Dj/roller outer diameter Ds (Dj/Ds)
(6) Trunnion journal diameter Dj/shaft diameter d (Dj/d)
(7) Needle roller length Ln/trunnion journal diameter Dj (Ln/Dj)

Dimensional ratios of the tripod type constant velocity universal Joint 1 according to the first embodiment are set as shown in Table 1.

TABLE 1

| | Item | Ratio (%) |
|---|---|---|
| (1) | Shaft diameter d/roller guide surface pitch circle diameter | 50-55 |
| | PCD (d/PCD) | |
| (2) | Trunnion barrel diameter dr/trunnion outer diameter SDj | 65-70 |
| | (dr/SDj) | |
| (3) | Small inner diameter D2/large inner diameter D1 of outer | 66-72 |
| | joint member (D2/D1) | |
| (4) | Roller width Ls/roller outer diameter Ds (Ls/Ds) | 24-27 |
| (5) | Trunnion journal diameter Dj/roller outer diameter Ds | 54-57 |
| | (Dj/Ds) | |
| (6) | Trunnion journal diameter Dj/shaft diameter d (Dj/d) | 83-86 |
| (7) | Needle roller length Ln/trunnion journal diameter Dj | 47-50 |
| | (Ln/Dj) | |

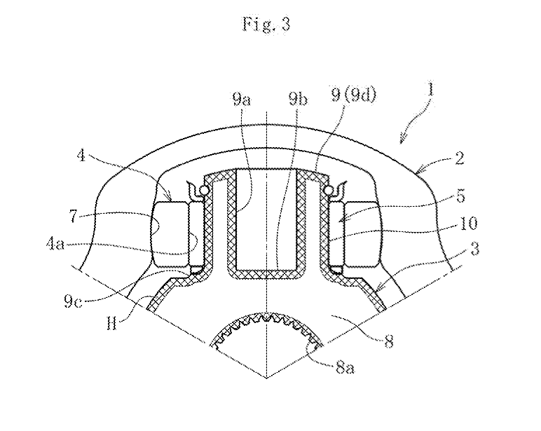

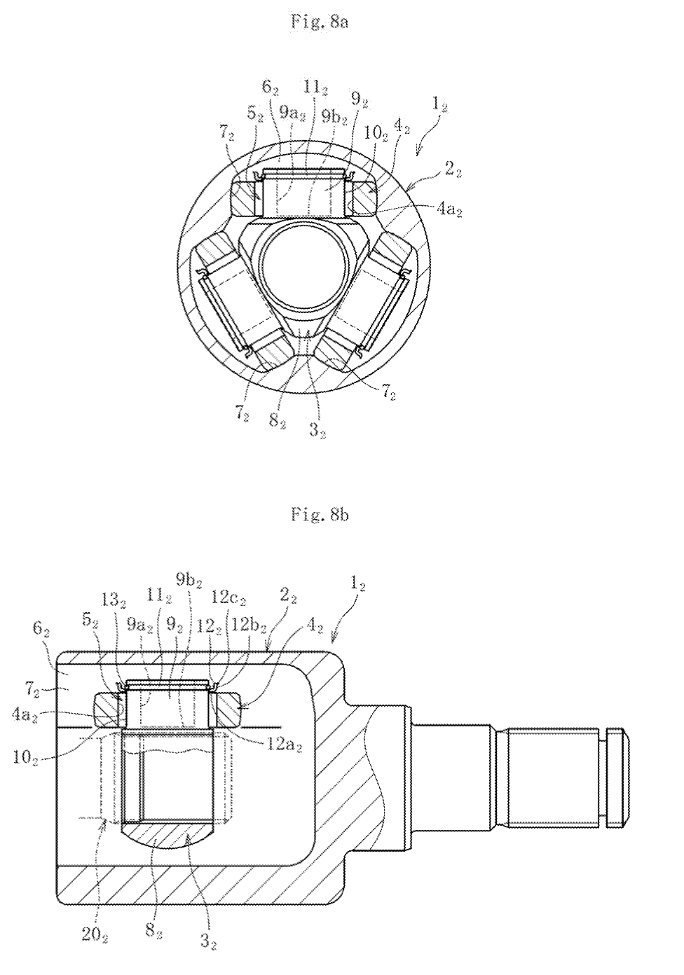

In the tripod type constant velocity universal joint 1 according to the first embodiment, in consideration of the strength and durability the outer diameter of the outer joint member is reduced with the dimensional ratios shown in Table 1 to achieve weight reduction and compactification. To achieve the weight reduction while maintaining the strength and life with the dimensional ratios shown in Table 1, the tripod type constant velocity universal joint 1 has the feature that a hollow hole is formed in the trunnion journal, and that a quench-hardened layer is formed on the surface of the hollow hole. This feature is described with reference to FIG. 3 to FIG. 6, FIG. 8 is a view for illustrating details of the tripod member 3, and is an illustration of a one-third portion of the transverse section of FIG. 1a. The remaining two-third portion which is omitted from illustration is also the same (this similarly applies to subsequent drawings). A hollow hole 9a having a cylindrical shape is formed at a center of the trunnion journal 9 of the tripod member 3, and the hollow hole 9a has a bottom portion 9b. A spline 8a is formed along an inner periphery of the trunnion barrel 8. On an entire surface of the tripod member 3, there is formed a substantially uniform quench-hardened layer H by carburizing, quenching, and tempering. The quench-hardened layer H is cross-hatched within the range of the effective hardened layer depth. This similarly applies to the subsequent drawings.

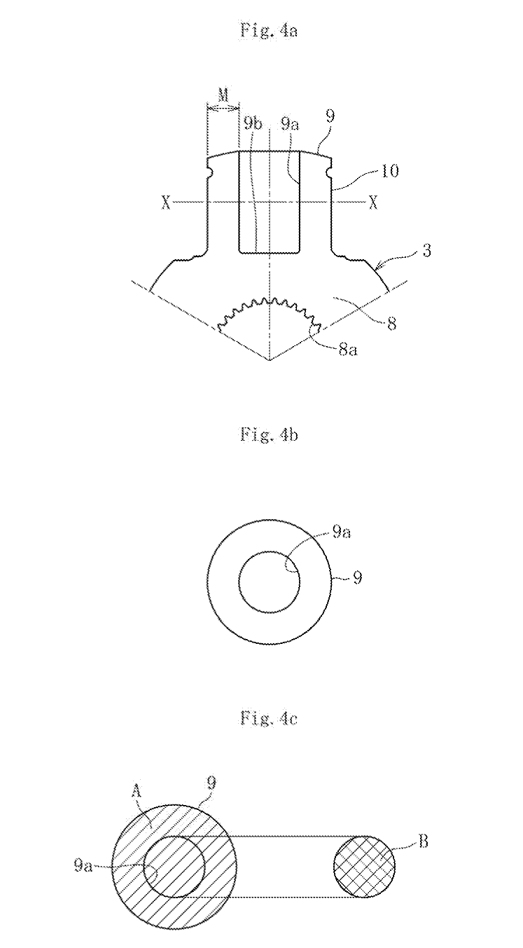

FIG. 4a is an illustration of a transverse section corresponding to a one-third portion of the tripod member 3. The tripod member 3 is made of chromium steel (for example, SCr420) or chromium-molybdenum steel (for example, SCM420). The hollow hole 9a of the trunnion journal 9 is formed of a forged surface obtained by forging the tripod member 3. The bottom portion 9b of the hollow hole 9a is formed, at a position deeper than, a lower end position (see FIG. 3) of the needle rollers 5 which are brought into contact with a cylindrical outer circumferential surface 10 of the trunnion journal 9. The trunnion barrel 8 and the spline 8a other than the trunnion journal 9 are the same as those of the related art.

The size of the hollow hole 9a is described with reference to FIG. 4b and FIG. 4c. FIG. 4b and FIG. 4c are each a sectional view taken along the line X-X of FIG. 4a. It is preferred that a ratio B/A of a transverse sectional area B of the hollow hole 9a to a transverse sectional area A of the trunnion journal 9 (including an area of the hollow hole 9a) be from 0.85 to 0.80 in view of sufficiency of a material in forging. Further, additionally in view of processing load and tool life, it is preferred that the ratio B/A be from 0.45 to 0.75. When the hollow hole 9a of the trunnion journal 9 is formed of the forged surface, additional processing is not required, thereby being capable of suppressing the manufacturing cost. A thickness M of the trunnion journal 9 illustrated in FIG. 4a differs depending on the joint size. However, in the case of use for a chive shaft of an automobile, the thickness M is approximately from 3 mm to 8 mm. In the first embodiment, description is made of the case in which the hollow hole 9a is formed by forging. However, not limited to this, the hollow hole 9a may be formed by machining such as cutting.

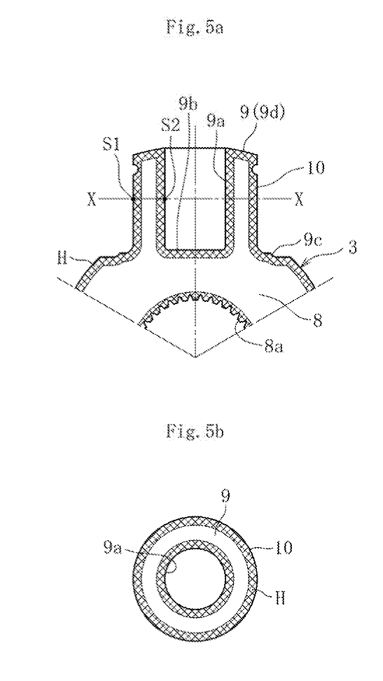

With reference to FIG. 5a and FIG. 5b, description is made of details of the quench-hardened layer H. FIG. 5b is a sectional view taken along the line X-X of FIG. 5a. The quench-hardened layer H is formed on the entire surface of the tripod member 3. The quench-hardened layer H is continuously formed so as to extend from a surface of the trunnion barrel 8 throughout, a root portion 9c, the cylindrical outer circumferential surface 10, a distal end portion 9d, the hollow hole 9a, and the bottom portion 9b of the trunnion journal 9. When the quench-hardened layer H which is continuous on the entire surface of the hollow hole 9a including the bottom portion 9b is formed, the strength and stiffness of the trunnion journal 9 can be increased. The surface hardness of the quench-hardened layer H is from about HRC 58 to about HRC 81. In the first embodiment, the hollow hole 9a is formed in the trunnion journal 9. Therefore, a core hardness of the trunnion journal 9 is higher than a core hardness of the trunnion barrel 8, thereby being capable of increasing the strength and stiffness of the trunnion journal 9. Further, as mentioned above, the bottom portion 9b of the hollow hole 9a is formed at the position deeper than the lower end position (see FIG. 3) of the needle rollers 5 which are brought, into contact with the cylindrical outer circumferential surface 10 of the trunnion journal 9. Therefore, increase in stiffness is expected in the entire region of the cylindrical outer circumferential surface 10 serving as the Inner raceway surface for the needle rollers 5. The quench-hardened layer H formed on the spline 8a is the same as that of the related art.

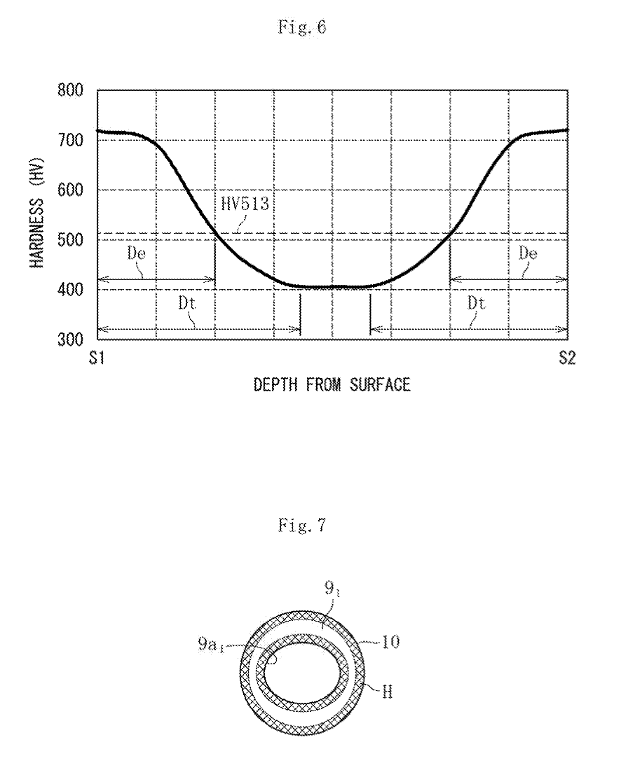

In FIG. 6, there is shown hardness distribution, from a surface S1 of the cylindrical outer circumferential surface 10 of the trunnion journal 9 of FIG. 5a to a surface 82 of the hollow hole 9a. The quench-hardened layer H having the effective hardened layer depth De is formed on both of a radially outer side and a radially inner side of the trunnion journal 9. An overall hardened layer depth of the quench-hardened layer H is represented by Dt.

In the first embodiment, the hollow hole 9a described above is formed in the trunnion journal 9. Therefore, even when the tripod member 3 has a large journal diameter Dj (see FIG. 2b), significant weight reduction can be achieved. Further, the quench-hardened layer H is formed in the hollow hole 9a (including the bottom portion 9b). Therefore, the rolling life, strength, strength, and stiffness of the tripod member 3 can be secured.

Description is made of a modification example of the hollow hole with reference to FIG. 7. FIG. 7 is a sectional view which is similar to FIG. 5b, and a transverse sectional view of the tripod member is omitted. As illustrated in FIG. 7, a hollow hole 9a₁ in the modification example has an elliptical cylinder shape, and a long axis of an ellipse is arranged in a direction orthogonal to an axis of the joint. With this configuration, when a transverse sectional area of the hollow hole 9a₁ is set to be equal to a transverse sectional area B1 of the hollow hole 9a of the first embodiment, the stiffness of the trunnion journal 9₁ can be further increased by forming the hollow hole 9a₁ having the elliptical cylinder shape. Other configurations, actions, processing method, and the like are the same as those of the first embodiment. Therefore, parts having the same function are denoted by the same reference symbols (except for the subscripts), and all the contents of the description in the first embodiment are applied to omit redundant description.

Next, description is made of a tripod type constant velocity universal joint according to a second embodiment of the present invention with reference to FIG. 8 to FIG. 13. FIG. 8a is a transverse sectional view for illustrating the tripod type constant velocity universal joint according to the second embodiment, and FIG. 8b is a longitudinal sectional view. A basic configuration of a tripod type constant velocity universal joint 1₂ according to the second embodiment is the same as that of the tripod type constant velocity universal joint 1 according to the first embodiment. Therefore, parts having the same functions are denoted, by the same reference symbols (except for the subscripts). The contents of the description related to FIG. 1a and FIG. 1b of the first embodiment are applied to omit redundant description.

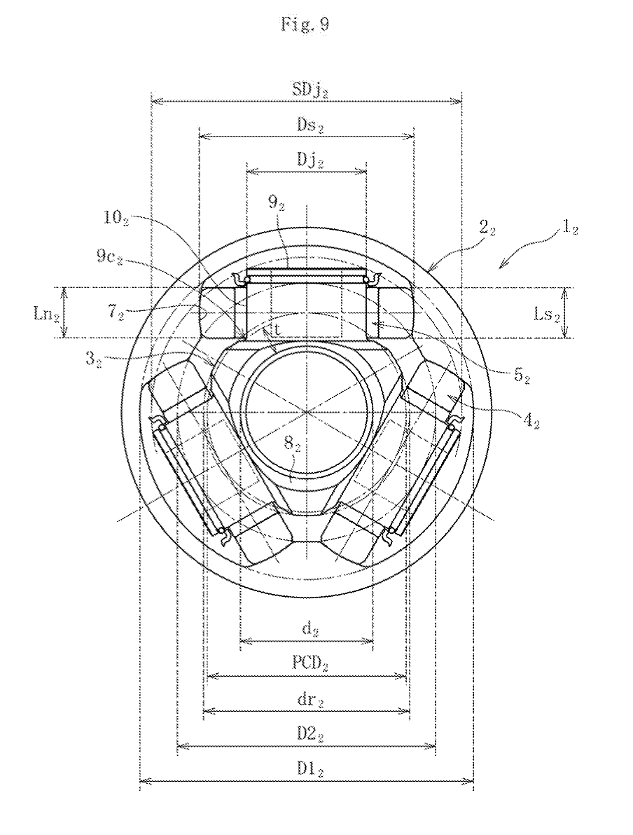

Dimensions of portions are illustrated in FIG. 9 which is a transverse sectional view for illustrating the tripod type constant velocity universal joint according to the second embodiment. Dimensions of the portions are defined as follows.

d₂-shaft diameter (spline large diameter), PCD₂: roller guide surface pitch circle diameter, dr₂: trunnion barrel diameter, SDj₂: trunnion outer diameter, D2₂: small inner diameter of outer joint member, D1₂: large inner diameter of older joint member, Ls₂: roller width, Ds₂: roller outer diameter, Dj₂: trunnion journal diameter, Ln₂: needle roller length

To achieve ultimate weight reduction and compactification of the joint outer diameter while maintaining the strength and life, the tripod type constant velocity universal joint la according to the second embodiment has dimensional settings greatly different from, those of the related art. First, description is made of a dimensional setting which is the basis of the tripod type constant velocity universal joint 1₂ according to the second embodiment.

The strength of the tripod type constant velocity universal joint 1₂ is basically set to the shaft strength or more, but the strength of the tripod member 3₂ and the strength of the spherical roller 4a need to be secured in the second place. In view of this, the tripod type constant velocity universal joint 1₂ according to the second embodiment has dimensional set lingo on the premise that the strength of the tripod member and the strength of the spherical roller 4₂ may be secured.

As a basic measure, assuming that the shaft diameter d₂ determined for each joint size has a constant value, the pitch, circle diameter PCD₂ of the roller guide surfaces 7₂ is reduced in accordance with a dimensional setting greatly different from that of the related art while securing a minimum thickness t of the trunnion barrel 8₂ at a root portion 9c₂ of the trunnion journal 9₂ in a torque applying direction.

To achieve the above-mentioned basic measure, it is necessary to secure the minimum thickness t of the trunnion barrel 8₂ at the root portion 9c₂ of the trunnion journal 9₂ in the torque applying direction even though the pitch circle diameter PCD₂ of the roller guide surfaces 7₂ is reduced as described above. Therefore, the dimensions are set such that the outer diameter Dj₂ of the trunnion journal 9₂ is increased. The outer diameter Ds₂ of the spherical roller 4₂ is also increased along with the increase in the outer diameter Dj₂ of the trunnion journal 9₂.

When the outer diameter Ds₂ of the spherical roller 4₂ is increased, the outer diameter of the outer joint member 2₂ is also increased. Therefore, the width Ls₂ of the spherical roller 4₂ is reduced so that the outer diameter of the outer joint member 2₂ is reduced.

When the width Ls₂ of the spherical roller 4₂ is reduced, the outer diameter of the outer joint member 2₂ is also reduced. As a result, the value of “small inner diameter D2₂/large inner diameter D1₂” is increased so that the unevenness between the small inner diameter D2₂ and the large inner diameter D1₂ is reduced. Through the reduction in the unevenness between the small inner diameter D2₂ and the large inner diameter D1₂, there is attained an advantage in the weight reduction and forgeability.

From the viewpoint of the life (durability), the outer diameter Dj₂ of the trunnion journal 9₂ is increased so that the number of needle rollers 5₂ to be mounted is increased to reduce a contact pressure. With this structure, the roller length Ln₂ is reduced while securing the life equivalent to that of the related art.

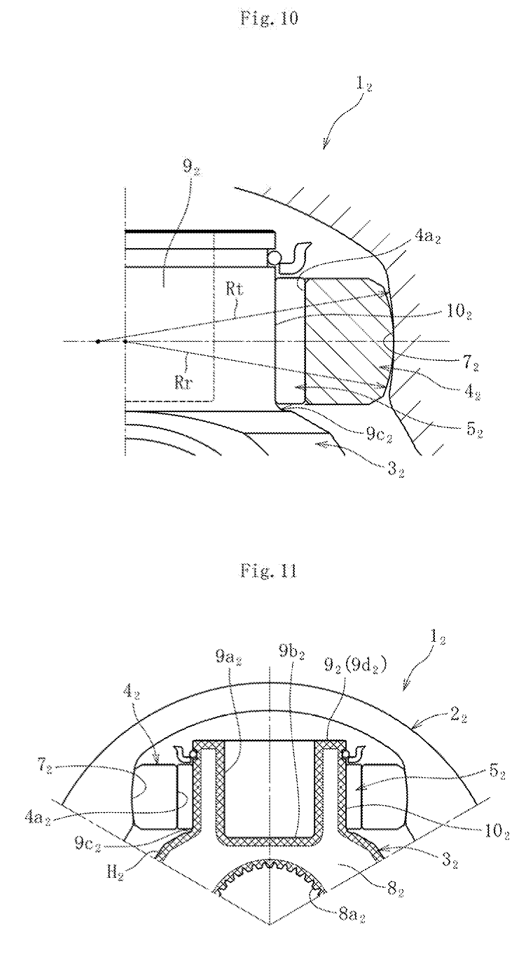

In general, there are two modes of contact between the spherical roller 4₂ and the roller guide surface 7₂. That is, there are angular contact and circular contact. The angular contact has a contact angle, and provides contact at two points. The circular contact provides contact at one point as illustrated in FIG. 10. In the second embodiment, when a curvature radius of the roller guide surface 7₂ is represented by Rt, and a curvature radius of the spherical roller 4₂ is represented by Rr, a contact ratio Rt/Rr is set to from about 1.02 to about 1.15. In the second embodiment, as described above, a width Ls₂ (see FIG. 9) of the spherical roller 4₂ is significantly reduced with respect to the related-art tripod type constant velocity universal joint, and hence the circular contact is preferred.

In Table 2, there is shown dimensional ratios serving as a basis of the tripod type constant velocity universal joint 1₂ according to the second embodiment.

TABLE 2

| | | Ratio |
|---|---|---|
| | Item | (%) |
| (1) | Shaft diameter d₂/roller guide surface pitch circle diameter | 62-70 |
| | PCD₂ (d₂/PCD₂) | |
| (2) | Trunnion barrel diameter dr₂/trunnion outer diameter SDj₂ | 63-70 |
| | (dr₂/SDj₂) | |
| (3) | Small inner diameter D2₂/large inner diameter D1₂ of | 73-80 |
| | outer joint member (D2₂/D1₂) | |
| (4) | Roller width Ls₂/roller outer diameter Ds₂ (Ls₂/Ds₂) | 20-27 |
| (5) | Trunnion journal diameter Dj₂/roller outer diameter Ds₂ | 54-57 |
| | (Dj₂/Ds₂) | |
| (6) | Trunnion journal diameter Dj₂/shaft diameter d₂ (Dj₂/d₂) | 87-93 |
| (7) | Needle roller length Ln₂/trunnion journal diameter Dj₂ | 40-47 |
| | (Ln₂/Dj₂) | |

According to the tripod type constant velocity universal joint 1₂ of the second embodiment, with the dimensional ratios qualitatively different from those of the related art, ultimate compactification of the joint outer diameter is achieved while maintaining the strength and life. To achieve the weight reduction while maintaining the strength and life with the dimensional ratios shown in Table 2, the tripod type constant velocity universal joint 1₂ has the feature that a hollow hole is formed in the trunnion journal, and that a quench-hardened layer is formed on the surface of the hollow hole. This feature is described with reference to FIG. 11 to FIG. 13. FIG. 11 is a view for illustrating details of the tripod member, and is an illustration of a one-third portion of the transverse section of FIG. 8a. A hollow hole 9a₂ having a cylindrical shape is formed at a center of the trunnion journal 9₂ of the tripod member 3₂, and the hollow bole 9a₂ has a bottom portion 9b₂. A spline 8a₂ is formed along an inner periphery of the trunnion barrel 8₂. As illustrated in FIG. 8b, the trunnion barrel 8₂ is spline-fitted on the shaft 20₂ to allow torque transmission therebetween. On a surface of the tripod member 3₂, there is formed a quench-hardened layer H₂ by carburizing, quenching, and tempering.

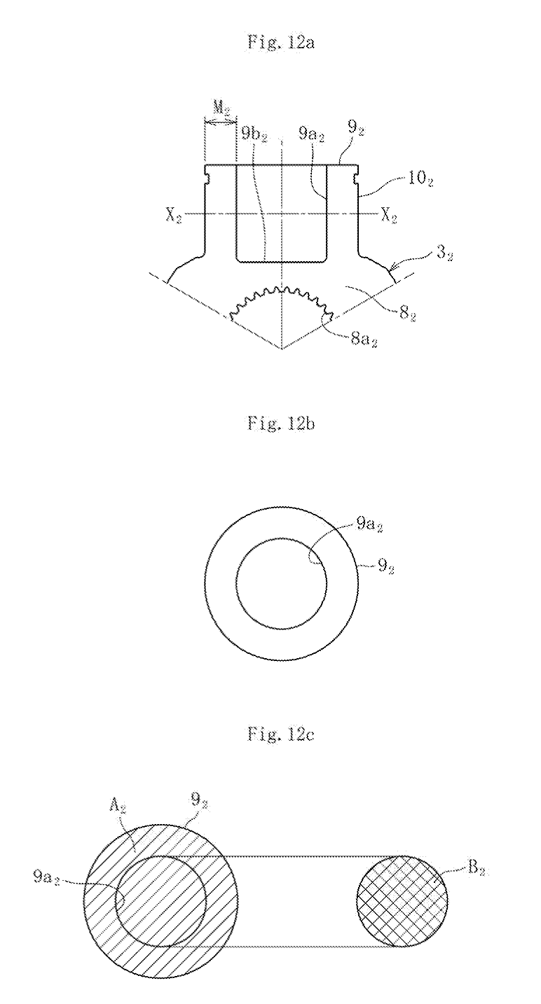

FIG. 12a is an illustration of a transverse section corresponding to a one-third portion of the tripod member 3₂. Similarly to the first embodiment, the tripod member 3₂ of the second embodiment is made of chromium steel (for example, SCr420) or chromium-molybdenum steel (for example, SCM 420). The hollow hole 9a₂ of the trunnion journal 9₂ is formed of a forged surface obtained by forging the tripod member 3₂. The bottom portion 9b₂ of the hollow hole 9a₂ is formed at a position deeper than a lower end position (see FIG. 11) of the needle rollers 5₂ which are brought into contact with a cylindrical outer circumferential surface 10₂ of the trunnion journal 9₂. The spline 8a₂ is the same as those of the related art.

The size of the hollow hole 9a₂ is described with reference to FIG. 12b and FIG. 12c. FIG. 12b and FIG. 12c are each a sectional view taken along the line X₂X₂ of FIG. 12a. It is preferred, also in the second embodiment, that a ratio B₂/A₂ of a transverse sectional area B₂ of the hollow hole 9a₂ to a transverse sectional area A₂ of the trunnion journal 9₂ (including an area of the hollow hole 9a₂) be from 0.35 to 0.80 in view of sufficiency of a material in forging. Further, additionally in view of processing load and tool life, it is preferred that the ratio B₂/A₂ be from 0.45 to 0.75. When the hollow hole 9a₂ of the trunnion journal 9₂ is formed of the forged surface, additional processing is not required, thereby being capable of suppressing the manufacturing cost. A thickness M₂ of the trunnion journal 9₂ illustrated in FIG. 12a differs depending on the joint size. However, also in the second embodiment, in the case of use for a drive shaft of an automobile, the thickness M₂ is approximately from 3 mm to 8 mm. In the second embodiment, description is made of the case in which the hollow hole 9a₂ is formed by forging. However, not limited to this, the hollow hole 9a₂ may be formed by machining such as cutting.

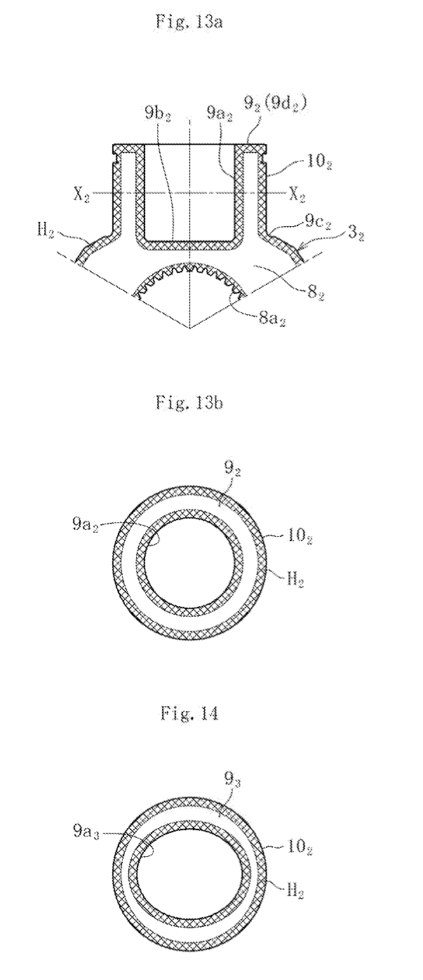

With reference to FIG. 13a and FIG. 13b, description is made of details of the quench-hardened layer H₂. FIG. 13b is a sectional view taken along the hue X₂-X₂ of FIG. 13a. The quench-hardened layer H₂ is formed on the entire surface of the tripod member The quench-hardened layer H₂ is continuously formed so as to extend from a surface of the trunnion barrel 8₂ throughout a root portion 9c₂, the cylindrical outer circumferential surface 10₂, a distal end portion 9d₂, the hollow hole 9a₂, and the bottom portion 9b₂ of the trunnion journal 9₂. When the quench-hardened layer H₂ which is continuous on the entire surface of the hollow hole 9a₂ including the bottom portion 9b₂ is formed, the strength and stiffness of the trunnion journal 9₂ can be increased. The surface hardness of the quench-hardened layer H₂ is from about HRC 58 to about HRC 61. In the second embodiment, the hollow hole 9a₂ is formed in the trunnion journal 9₂. Therefore, a core hardness of the trunnion journal 9₂ is higher than a core hardness of the trunnion barrel 8₂, thereby being capable of increasing the strength and stiffness of the trunnion journal 9₂. Further, as mentioned above, the bottom portion 9b₂ of the hollow hole 9a₂ is formed at the position deeper than the lower end position (see FIG. 11) of the needle rollers 5₂ which are brought into contact with the cylindrical outer circumferential surface 10₂ of the trunnion journal 9₂. Therefore, increase in stiffness is expected in the entire region of the cylindrical outer circumferential surface 10₂ serving as the inner raceway surface for the needle rollers 5₂. The quench-hardened layer H₂ formed on the spline 8a₂ is the same as that of the related art. Although illustration is omitted, hardness distribution from the surface of the cylindrical outer circumferential surface 10₂ of the trunnion journal 9₂ of FIG. 13a to the surface of the hollow hole 9a₂ is the same as that of the first embodiment.

In the second embodiment, as illustrated in Table 2, the hollow hole 9a₂ is formed in the trunnion journal 9₂ with a significantly large journal diameter Dj₂. Therefore, significant weight reduction of the tripod member 3₂ can be achieved. Further, the quench-hardened layer H₂ is formed in the hollow hole 9a₂ (including the bottom portion 9b₂). Therefore, the rolling life, strength, strength, and stiffness of the tripod member 3₂ can be secured.

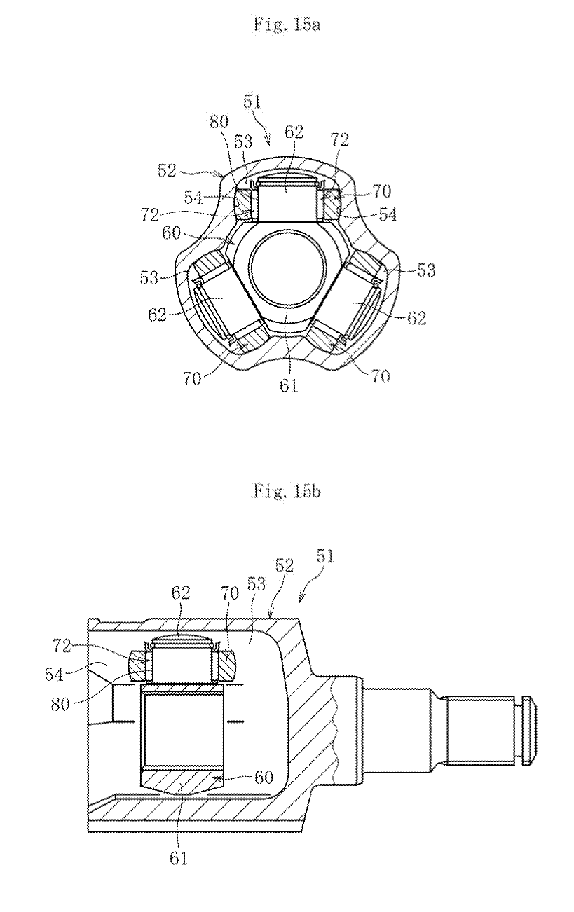

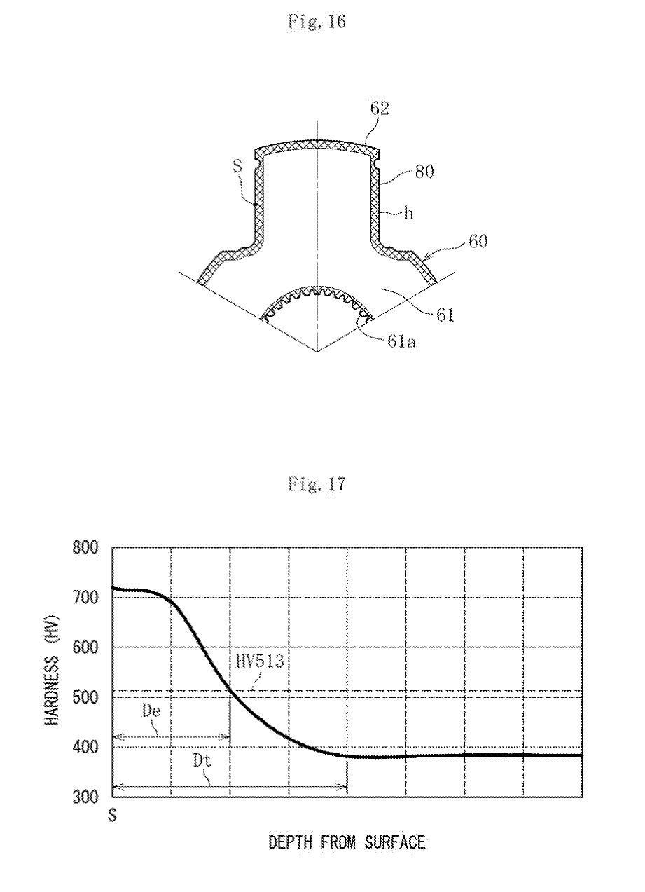

Description is made of a modification example of the hollow hole with reference to FIG. 14. FIG. 14 is a sectional view which is similar to FIG. 13b, and a transverse sectional view of the tripod member is omitted. As illustrated in FIG. 14, a hollow hole 9a₃ in the modification example has an elliptical cylinder shape, and a long axis of an ellipse is arranged in a direction orthogonal to an axis of the joint. With this configuration, when a transverse sectional area of the hollow hole 9a₃ is set to be equal to a transverse sectional area B₂ of the hollow hole 9a₂ of the second embodiment, the stiffness of the trunnion journal 9₃ can be further increased by forming the hollow hole 9a₃ having the elliptical cylinder shape. Other configurations, actions, processing method, and the like are the same as those of the second embodiment. Therefore, parts having the same function are denoted by the same reference symbols (except for the subscripts), and all the contents of the description in the second embodiment are applied to omit redundant description.

In the second embodiment, the root portion 9c₂ of the trunnion journal 9₂ of the tripod member 3₂ is a rib for directly guiding the needle rollers 5₂, but the present invention is not limited thereto. A shoulder portion may be formed on the root portion and a separate inner washer may be interposed between the shoulder portion and the end portions of the needle rollers.

In the embodiments and the modification examples, description is made of, as an example, the tripod type constant velocity universal joint 1, 1₂ of the single-roller type in which the spherical roller 4, 4₂ is rotatably mounted to the cylindrical outer circumferential surface 10, 10a of the trunnion journal 9, 9₂ through intermediation of the needle rollers 5. However, not limited to this type, the present invention may be applied to a tripod type, constant velocity universal, joint of a double-roller type in which a unit including spherical rollers (outer rollers), needle rollers, and inner rings is externally fitted to a trunnion journal,

The present invention is not limited to the above-mentioned embodiments. As a matter of course, the present invention may be carried out in various other embodiments without departing from the gist of the present invention. The scope of the present invention is defined in claims, and encompasses the meanings of equivalents described in claims and all changes within the scope of claims.

### DESCRIPTION OF REFERENCE SIGNS

1, 1a tripod type constant velocity universal joint

2, 2₂ outer joint member

3, 3₂ tripod member

4, 4₂ spherical roller

5, 5₂ needle roller

6, 6₂ track groove

7, 7₂ roller guide surface

8, 8₂ trunnion barrel

9, 9₂ trunnion journal

9a, 9a₂ hollow hole

9b, 9b₂ bottom portion

10, 10₂ cylindrical outer circumferential surface

H, H₂ quench-hardened layer

De effective hardened layer depth

1-6. (canceled)

7. A tripod type constant velocity universal joint, comprising:
an outer joint member having track grooves formed at trisected positions in a circumferential direction of the outer joint member to extend in an axial direction thereof;
a tripod member comprising:
a trunnion barrel to be spline-fitted on a shaft to allow torque transmission therebetween; and
trunnion journals radially projecting from trisected positions on the trunnion barrel in the circumferential direction; and
spherical rollers each fitted in a rotatable manner about each of the trunnion journals through intermediation of a plurality of needle rollers,
the spherical rollers being received in the track grooves, and each having an outer spherical surface guided by roller guide surfaces formed on both side walls of each of the track grooves,
wherein hollow holes are formed in the trunnion journals, respectively, and
wherein a quench-hardened layer is formed on each of outer circumferential surfaces of the trunnion journals and surfaces of the hollow holes.

8. The tripod type constant velocity universal joint according to claim 7,
wherein the hollow holes each have a cylindrical shape having a bottom portion, and wherein the quench-hardened layer is formed also on a surface of the bottom portion.

9. The tripod type constant velocity universal joint according to claim 7,
wherein the hollow holes each have an elliptical cylinder shape having a bottom portion, and a long axis of an ellipse is arranged in a direction orthogonal to an axis of the tripod type constant velocity universal joint, and
wherein the quench-hardened layer is formed also on a surface of the bottom portion.

10. The tripod type constant velocity universal joint according to claim 7, wherein the heat treatment comprises carburizing, quenching, and tempering.

11. The tripod type constant velocity universal joint according to claim 7, wherein a core hardness of the trunnion journals is higher than a core hardness of the trunnion barrel.

12. The tripod type constant velocity universal joint according to claim 7, wherein the hollow holes of the trunnion journals are each formed of a forged surface.
